(19) United States
(12) Patent Application Publication
(10) Pub. No.: US 2010/0272397 A1
(43) Pub. Date: Oct. 28, 2010

(54) OPTICAL CONNECTOR

(76) Inventors: Yasunari KOMAKI, Kyoto-shi (JP); Masaya Nakagawa, Kyoto-shi (JP)

Correspondence Address: WENDEROTH, LIND & PONACK, L.L.P., 1030 15th Street, N.W.,, Suite 400 East, Washington, DC, 20005-1503, US

(21) Appl. No.: 12/765,130

(22) Filed: Apr. 22, 2010

(30) Foreign Application Priority Data
Apr. 27, 2009 (JP) 2009-107958

(51) Int. Cl. G02B 6/38

(52) U.S. Cl. 385/72

(57) ABSTRACT

Provided is an optical connector in which a through-hole of a housing is opened in a side surface of the housing and a ferrule can be mounted to the housing from an opening portion formed in the side surface of the housing. Thus, it is unnecessary to constitute the housing by a plurality of components. Consequently, reduction in the numbers of components and assembly steps and reduction in cost can be achieved.

### TECHNICAL FIELD

The present invention relates to an optical connector for connecting an optical fiber to another optical fiber or an optical element.

### BACKGROUND ART

For example, in JP 2001-56420 A, there is described an optical connector including a ferrule (27) having a flange (26), and a housing (constituted by a front portion (12) and a rear portion (13)) for holding the ferrule. A through-hole is formed in the housing, and the ferrule is held in an inner periphery of the through-hole. Specifically, the through-hole is formed in each of the front portion (12) and the rear portion (13) of the housing. A forward end side of the ferrule is inserted into the through-hole of the front portion, and a proximal end side of the ferrule (which is hereinafter represented as a side opposite to the forward end side thereof) is inserted into the through-hole of the rear portion. In this state, the front portion and the rear portion are fixed to each other, and thus the ferrule is mounted in the inner periphery of the through-hole of the housing.

The above-mentioned optical connector has a spring (coil spring (29)) mounted between the flange of the ferrule and the rear portion (13) of the housing, and hence the ferrule is biased toward the front portion (12). When such optical connector on one part is connected to an optical connector on the other part through an optical adapter, a forward end of the ferrule on the one part is brought into contact with a ferrule on the other part. Consequently, the ferrule on the one part retreats against resilience of the coil spring. Owing to a buffer function of the spring, the forward ends of the ferrules can be reliably brought into contact with each other.

### Citation List

Patent Literature

### Patent Literature 1: JP 2001-56420 A

### SUMMARY OF INVENTION

### Technical Problem

As described above, owing to a configuration in which the ferrule is completely received in the through-hole of the housing constituted by the front portion (12) and the rear portion (13), it is possible to reliably protect the ferrule from external impact. However, an optical connector used behind the wall (BTW), i.e., in an inside of a module box or the like, is rarely subjected to external contact, and hence the external impact is less likely to be applied thereto in comparison with an optical connector used on the wall (OTW). Thus, in the optical connector used on a place where the optical connector is rarely subjected to the external impact, the configuration having the above-mentioned housing constituted by a plurality of components becomes sometimes excessive.

An object of the present invention is therefore to simplify a structure of the optical connector and to achieve reduction in cost.

### Solution to Problem

In order to achieve the above-mentioned object, the present invention provides an optical connector including: a ferrule including a flange portion; and a housing including a through-hole formed to hold the ferrule therein, in which the through-hole is opened in a side surface of the housing, and the ferrule is allowed to be mounted to an inner periphery of the through-hole from an opening portion formed in the side surface.

As described above, the through-hole is opened in the side surface of the housing, and the ferrule is allowed to be mounted to the inner periphery of the through-hole from an opening portion formed in the side surface. Thus, it is unnecessary to constitute the housing by a plurality of components, and reduction in the numbers of components and assembly steps and reduction in cost can be achieved. The above-mentioned optical connector can be preferably used on a place where the optical connector is rarely subjected to external contact (behind the wall, for example).

The optical connector may further include a reference surface formed integrally with the housing, for regulating retreat of the ferrule by being brought into contact with the flange portion of the ferrule from a proximal end side thereof. When the optical connector is mounted to an optical adapter, the ferrule on one part of the optical connector is pushed to the proximal end side by being brought into contact with a ferrule on the other part, and thus the flange portion is brought into contact with the reference surface. In this way, the retreat of the ferrule is regulated. As described above, the ferrule is positioned in the housing during use of the optical connector (during mounting to the optical adapter) by the reference surface provided integrally with the housing, and hence it is possible to omit a spring, and to achieve further reduction in cost. Such optical connector on the one part has no buffer function of the spring, and hence can be preferably used in a case where the optical connector on the other part connected thereto has a buffer function of the spring or the like. In this case, when a position of the reference surface is set within a movable range of the ferrule on the other part, it is possible to reliably bring the forward ends of the ferrules into contact with each other by the buffer function of the ferrule on the other part.

Incidentally, it is desirable that a fiber core of an optical fiber inserted through the ferrule be arranged at a central axis position of the forward end of the ferrule. However, actually, due to factors such as eccentricity of an insertion hole with respect to an outer peripheral surface of the ferrule, eccentricity of the optical fiber with respect to an inner peripheral surface of the insertion hole, and eccentricity of the fiber core with respect to an outer peripheral surface of the optical fiber, the fiber core is arranged to be eccentric to the central axis position of the ferrule. For example, when, of a pair of ferrules of optical connectors connected together through the optical adapter, a fiber core of one ferrule is eccentric in an upward direction and a fiber core of the other ferrule is eccentric in a downward direction, deviation of the fiber cores is increased when the ferrules are brought into contact with each other. In contrast, when eccentric directions of the fiber cores of both the ferrules are aligned with a predetermined direction (upward direction, for example), the deviation of the fiber cores can be decreased. (As described above, an operation for aligning the eccentric directions of the fiber cores with the predetermined direction is referred as to “centering”.)

When the ferrule is detachably attached to the housing, it is possible to easily perform centering. That is, in a state in which the ferrule is mounted to the housing, the eccentric direction of the fiber core of the optical fiber inserted through the ferrule is ascertained. Then, the ferrule is temporarily detached from the housing, rotated by a predetermined angle, and re-mounted to the housing. In this state, the eccentric direction of the fiber core is ascertained. The above-mentioned operation is repeated, and the ferrule is mounted to the housing at a position at which the eccentric direction is aligned with the predetermined direction. Consequently, the centering is completed.

When provided is a cover portion which is formed integrally with the housing, covers an outer periphery of the ferrule projecting to the proximal end side thereof relative to the housing, and extends to the proximal end side relative to a proximal end of the ferrule, it is possible to protect the optical fiber inserted into the ferrule.

When the ferrule is held in close contact with the housing on a cylindrical outer peripheral surface of the ferrule in a peripheral region extending over more than half of a circumference of the cylindrical outer peripheral surface, the ferrule can be restrained in an entire radius direction. Therefore, it is possible to reliably hold the ferrule by the housing.

### ADVANTAGEOUS EFFECTS OF INVENTION

As described above, according to the present invention, it is possible to simplify a structure of the optical connector and to achieve reduction in cost.

### BRIEF DESCRIPTION OF DRAWINGS

FIG. 1A A perspective view of an optical connector.

FIG. 1B A perspective view of the optical connector.

FIG. 2A A side view of the optical connector.

FIG. 2B A plan view of the optical connector.

FIG. 2C A front view of a forward end side of the optical connector.

FIG. 2D A front view of a proximal end side of the optical connector.

FIG. 3A A cross-sectional view taken along the line A-A of FIG. 2B.

FIG. 3B A cross-sectional view taken along the line B-B of FIG. 2A.

FIG. 3C A cross-sectional view taken along the line C-C of FIG. 2A.

FIG. 3D A cross-sectional view taken along the line D-D of FIG. 2A.

FIG. 4 An enlarged view of FIG. 3A.

### DESCRIPTION OF EMBODIMENTS

In the following, an embodiment of the present invention is described with reference to the drawings.

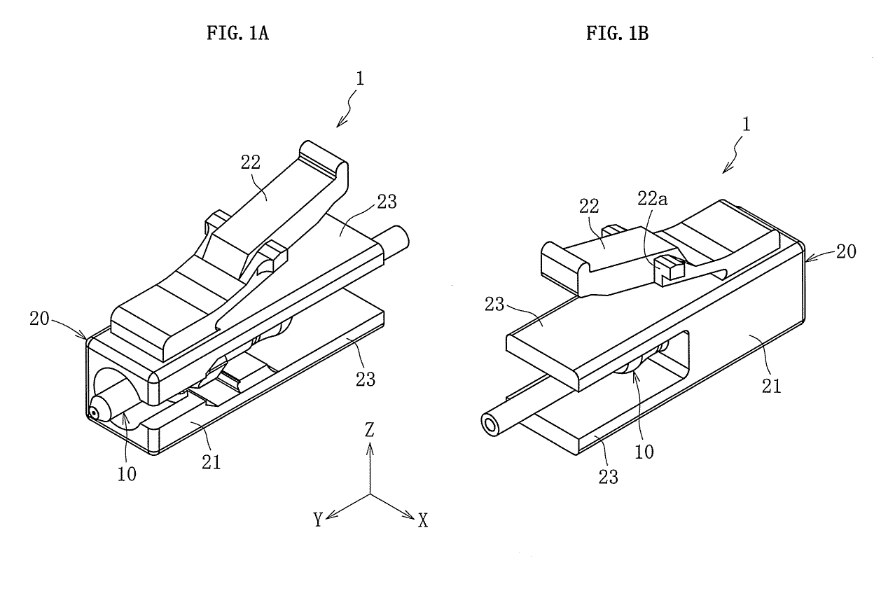

As illustrated in FIGS. 1A and 1B, an optical connector 1 according to the embodiment of the present invention includes a ferrule 10 and a housing 20 for holding the ferrule 10. The optical connector 1 is mounted to an optical adapter (not shown), and is a so-called LC-type optical connector in which the ferrule 10 and the housing 20 are prevented from slipping off through engaging, with a locking portion of the optical adapter, a latch 22 provided to the housing 20 of the optical connector 1. Note that, in the following, for convenience of the description, a central axis direction (Y direction in FIGS. 1A and 1B) of the ferrule 10 mounted to the housing 20 is referred to as an “axial direction”, a side on which a capillary 11 of the ferrule 10 projects from the housing 20 in the axial direction is referred to as a forward end side, and a side opposite thereto is referred to as a proximal end side. Further, a Z direction illustrated in FIGS. 1A and 1B is referred to as an up-down direction, a side on which the latch 22 of the housing 20 is provided is referred to as an upper side, and a side opposite thereto is referred to as a lower side. Moreover, a direction (X direction in FIGS. 1A and 1B) orthogonal to both of the axial direction and the up-down direction is referred to as a width direction.

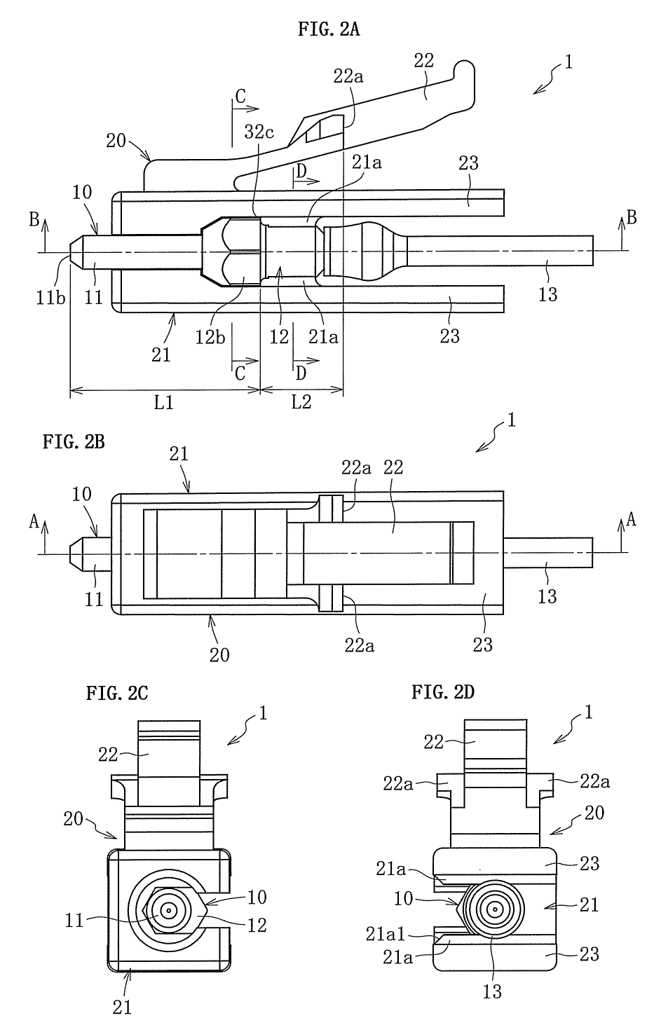

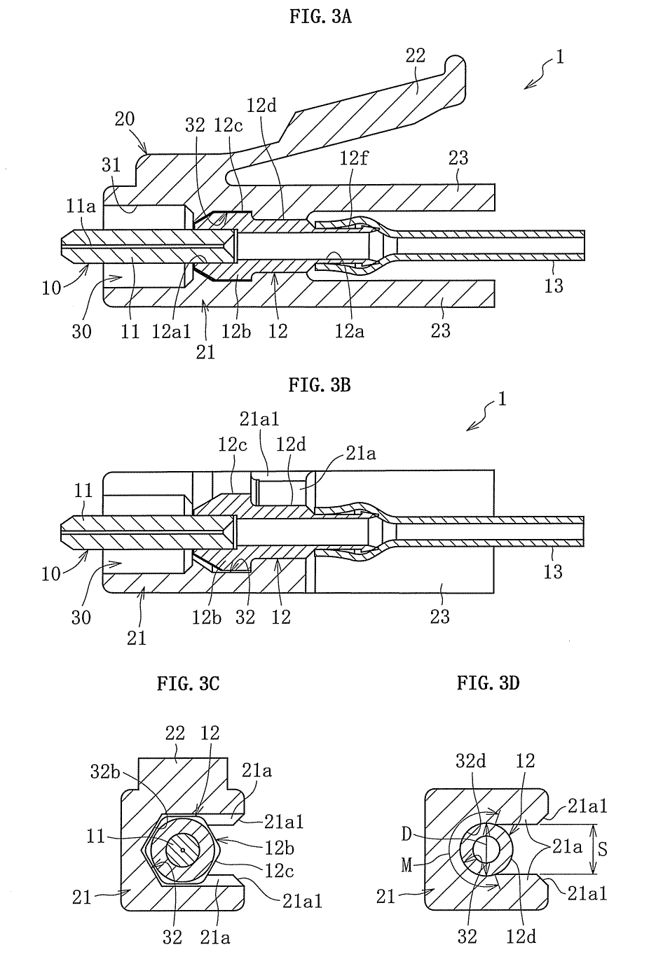

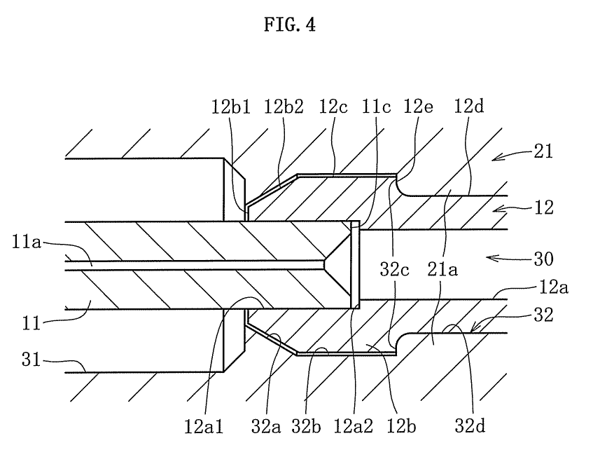

The ferrule 10 is attached to a forward end of an optical fiber (optical fiber wire or optical fiber wire with coating (not shown)). As illustrated in FIG. 2A, the ferrule 10 includes the capillary 11, a capillary holding portion 12, and a protective tube 13. The capillary 11 is made of a material such as ceramics (zirconia, for example) or glass, and has a micropore 11a which extends in the axial direction and through which the optical fiber is inserted (see FIG. 3A). The capillary holding portion 12 is made of a metal material such as brass, and has an inner hole 12a which extends in the axial direction and through which the optical fiber is inserted. On the forward end side of the inner hole 12a, there is provided a fixation hole 12a1 having a diameter slightly larger than a diameter of the inner hole 12a. The capillary 11 is press-fitted and fixed into the fixation hole 12a1. A radial shoulder surface 12a2 is formed between the inner hole 12a and the fixation hole 12a1, and an axial gap is formed between the shoulder surface 12a2 and a proximal end 11c of the capillary 11 (see FIG. 4).

A flange portion 12b projecting to a radially outer side thereof is formed at the forward end of the capillary holding portion 12. As illustrated in FIG. 4, in the flange portion 12b, there are formed a forward end surface 12b1 extending in a radial direction, a tapered surface 12b2 extending from the forward end surface 12b1 to the proximal end side to gradually increase in diameter to the proximal end side, and a larger-diameter outer peripheral surface 12c extending from the tapered surface 12b2 to the proximal end side. On the proximal end side of the flange portion 12b in an outer peripheral surface of the capillary holding portion 12, a smaller-diameter outer peripheral surface 12d is formed. The larger-diameter outer peripheral surface 12c has a regular hexagonal cross-section in the radial direction (see FIG. 3C), and the smaller-diameter outer peripheral surface 12d has a cylindrical surface (see FIG. 3D). A shoulder surface 12e is formed between the larger-diameter outer peripheral surface 12c and the smaller-diameter outer peripheral surface 12d (see FIG. 4).

In the proximal end of the capillary holding portion 12, there is provided a cylinder portion 12f which includes a claw portion at its end and has a diameter still smaller than a diameter of the smaller-diameter outer peripheral surface 12d (see FIG. 3A). The cylinder portion 12f projects to the proximal end side relative to a main body 21 of the housing 20. The optical fiber (not shown) is inserted through an inner periphery of the cylinder portion 12f, and the protective tube 13 is mounted so as to cover both of the outer peripheral surface of the cylinder portion 12f and the outer peripheral surface of the optical fiber. The protective tube 13 is made of a material (fluororesin or rubber, for example) being elastic enough to be able to be mounted on the outer periphery of the cylinder portion 12f. Further, the protective tube 13 may be made of a material having a heat shrinkage property and be formed into a so-called heat-shrinkable tube. By being caused to shrink by heating, the protective tube 13 may be brought into close contact with the cylinder portion 12f and the optical fiber. The claw portion of the cylinder portion 12f bites into an inner peripheral surface of the protective tube 13, and thus the protective tube 13 is elastically deformed to the radially outer side thereof. As a result, the protective tube 13 and the claw portion are engaged with each other in the axial direction, and hence the protective tube 13 is regulated from slipping off.

The housing 20 is integrally die-molded (injection-molded, for example) of a resin material, etc. The housing 20 includes the main body 21 of a substantially rectangular parallelepiped, the latch 22 provided on one side surface (upper surface) of the main body 21, and a cover portion 23 extending from the main body 21 to the proximal end side.

The main body 21 has a through-hole 30 formed to pass through the main body 21 in the axial direction. The ferrule 10 is held in an inner periphery of the through-hole 30. The through-hole 30 is opened in a side surface (surface except for end surfaces on both sides in the axial direction) of the housing 20. In the illustrated example, the through-hole 30 is opened in one side surface in the width direction of the main body 21 over an entire axial length thereof. Thus, the main body 21 is formed into a substantially C-shape in its front view (see FIGS. 2C and 2D). Note that, except for a case where the through-hole 30 is opened in the side surface as in the illustrated example, the through-hole 30 may be opened in the other side surface in the width direction of the housing 20 or a side surface on the lower side of the housing 20.

The through-hole 30 includes a larger-diameter hole 31 opened in the forward end surface of the main body 21, and a holding hole 32 provided on the proximal end side of the larger-diameter hole 31 (see FIG. 3A). The capillary 11 is placed in the inner periphery of the larger-diameter hole 31, and the capillary holding portion 12 is held in the inner periphery of the holding hole 32.

As illustrated in FIG. 4, in the inner peripheral surface of the holding hole 32, there are formed a partially-tapered inner surface 32a gradually decreasing in diameter to the forward end side to be opened in one side surface in the width direction of the housing 20, a partially-angled inner surface 32b extending from the partially-tapered inner surface 32a to the proximal end side to be opened in the one side surface in the width direction thereof (see FIG. 3C), and reference surfaces 32c extending upright from the partially-angled inner surface 32b radially inward. The partially-tapered inner surface 32a, the partially-angled inner surface 32b, and the reference surfaces 32c are die-molded integrally with the housing 20. The partially-tapered inner surface 32a and the partially-angled inner surface 32b are opposed to the flange portion 12b of the capillary holding portion 12 through a gap, and the reference surfaces 32c are brought into contact with the proximal-end side surface 12e (shoulder surface 12e) of the flange portion 12b from the proximal end side. The reference surfaces 32c are provided to end surfaces on the forward end side of protrusions 21a projecting from two upper and lower positions in an inner surface of the holding hole 32 of the main body 21.

As illustrated in FIG. 3D, at a deep side in the width direction (an opposite side to an opening side) of the holding hole 32, which is formed between protrusions 21a provided at the upper and lower positions, there is provided a partially-rounded inner surface 32d for holding the smaller-diameter outer peripheral surface 12d of the capillary holding portion 12 of the ferrule 10. The partially-rounded inner surface 32d is held in close contact with the smaller-diameter outer peripheral surface 12d in a peripheral region M extending over more than half of a circumference of the smaller-diameter outer peripheral surface 12d. Thus, the ferrule 10 is restrained in an entire radius direction. In the illustrated example, the partially-rounded inner surface 32d is held in close contact with the smaller-diameter outer peripheral surface 12d in an entire region on a deep side in the width direction with respect to an upper end and a lower end of the smaller-diameter outer peripheral surface 12d and in a partial region on the opening side in the width direction with respect to the upper end and the lower end thereof. An inner diameter of the partially-rounded inner surface 32d of the housing 20 before mounted with the ferrule 10 is slightly smaller than an inner diameter D of the smaller-diameter outer peripheral surface 12d of the ferrule 10, and is set to be slightly larger than a space S in the up-down direction between the protrusions 21a. Therefore, the ferrule 10 is mounted to the partially-rounded inner surface 32d of the holding hole 32 of the housing 20 while elastically deforming the housing 20 by pushing the smaller-diameter outer peripheral surface 12d in between the upper and lower protrusions 21a. Note that, a configuration of the partially-rounded inner surface 32d is not limited to the above-mentioned one. For example, the inner diameter of the partially-rounded inner surface 32d may be equal to the space S in the up-down direction between the upper and lower protrusions 21a. In this case, through press-fitting the ferrule 10 to the partially-rounded inner surface 32d while deforming the housing 20, the partially-rounded inner surface 32d can be held in close contact with the smaller-diameter outer peripheral surface 12d of the ferrule 10 in the peripheral region extending over more than half of the circumference of the smaller-diameter outer peripheral surface 12d.

The latch 22 extends obliquely upward from a forward-end side portion of the upper surface of the main body 21 to the proximal end side, and includes on its middle portion a locking surface 22a facing the proximal end side. In a state in which the optical connector 1 is mounted to the optical adapter, the locking surface 22a is engaged with the locking portion of the optical adapter in the axial direction, and thus the optical connector 1 is regulated from slipping off from the optical adapter. The latch 22 is pushed downward while being elastically deformed, and engagement between the locking surface 22a and the locking portion of the optical adapter is released. Consequently, the optical connector 1 can be detached from the optical adapter.

In the optical connector 1, in order to reliably bring the forward end of the ferrule 10 of the optical connector 1 on one part into contact with a ferrule of an optical connector on the other part connected thereto through the optical adapter, it is necessary to set a projecting amount of the capillary 11 with respect to the housing 20 within a range defined by a predetermined standard. Specifically, as illustrated in FIG. 2A, it is necessary to set an axial length L1 between a forward end 11b of the capillary 11 and the reference surfaces 32c of the housing 20, and an axial length L2 between the reference surfaces 32c and the locking surface 22a. As in this embodiment, when the locking surface 22a and the reference surfaces 32c are die-molded integrally with the housing 20, those surfaces can be finished with high dimensional accuracy. Thus, it is possible to set the projecting amount of the capillary 11 with respect to the housing 20 with good accuracy.

The cover portion 23 covers the outer periphery of the cylinder portion 12f of the ferrule 10 projecting to the proximal end side relative to the main body 21, and extends to the proximal end side beyond the proximal end of the cylinder portion 12f. In the illustrated example, a pair of long plate-like members provided above and below the cylinder portion 12f constitute the cover portion 23. As in the illustrated example, the cylinder portion 12f and a connecting portion connected to the optical fiber are covered with the protective tube 13, and the cover portion 23 protects the connecting portion from above and below. Thus, it is possible to prevent a situation in which the optical fiber (not shown) is bent at an entrance portion (proximal end) of the cylinder portion 12f when operating the latch 22.

The optical connector 1 having the above-mentioned configuration is assembled as follows. First, an adhesive is applied to the inner periphery of the ferrule 10 mounted with the protective tube 13, and the adhesive is cured after the optical fiber (not shown) is inserted through the inner periphery of the ferrule 10 applied with the adhesive. Consequently, the ferrule 10 and the optical fiber are integrated together. In this state, after eliminating a portion of the optical fiber sticking out of the forward end 11b, the forward end 11b of the capillary 11 is polished and finished with high accuracy. The ferrule 10 thus formed is inserted in the inner periphery of the through-hole 30 from the opening portion formed in the side surface of the main body 21 of the housing 20. Specifically, while guided by cutout portions 21a1 provided at the ends on the opening side of the protrusions 21a, the smaller-diameter outer peripheral surface 12d of the capillary holding portion 12 of the ferrule 10 is pushed in between the pair of upper and lower protrusions 21a provided on the inner peripheral surface of the through-hole 30, and is press-fitted therebetween while elastically deforming the housing 20 and expanding the space between the protrusions 21a. When the smaller-diameter outer peripheral surface 12d reaches the partially-rounded inner surface 32d located at the deep portion in the width direction, the housing 20 is elastically restored, and the partially-rounded inner surface 32d is held in close contact with the smaller-diameter outer peripheral surface 12d. Thus, the ferrule 10 is held by the housing 20 (see FIGS. 3B and 3D). In this way, in order that the housing 20 is deformed within its elastic range when the ferrule 10 is mounted to the housing 20, a diameter of the smaller-diameter outer peripheral surface 12d of the ferrule 10 and the space between the upper and lower protrusions 21a are appropriately set. As a result, the ferrule 10 is detachably attached to the housing 20, and to easily perform a centering operation described below. Note that, the forward end 11b of the capillary 11 may be polished not only before the ferrule 10 is mounted to the housing 20 as described above but also after the ferrule 10 is mounted to the housing 20. However, in comparison with a case where the ferrule 10 is polished while being assembled to the housing 20, a backlash during polishing and assembly tolerance between members are more likely to be suppressed and polishing with higher accuracy can be attained in a case where the ferrule 10 is polished alone as described above. Therefore, it is possible to finish the forward end 11b with higher accuracy.

Then, the centering operation is performed. Specifically, in a state in which the ferrule 10 is mounted to the housing 20, a fiber core is connected to an optical connector (not shown) being eccentric in a predetermined direction (upward direction, for example), and splice loss in connection is measured. Then, the ferrule 10 is detached from the housing 20, and rotated by a predetermined angle (60°, for example). The ferrule 10 is re-mounted to the housing 20, and the splice loss is measured. The above-mentioned operation is repeated. An eccentric direction of the fiber core of the optical connector 1 is considered to be most close to the predetermined direction (upward direction, for example) when the splice loss becomes lowest, and the ferrule 10 is mounted in this direction. With the above-mentioned operation, assembly of the optical connector 1 is completed. Note that, a centering method is not limited to the above-mentioned one. For example, centering may be performed after the splice loss is measured in the ferrule 10 alone and the eccentric direction of the fiber core is ascertained. Thereafter, the ferrule 10 may be mounted to the housing 20.

As described above, in the optical connector of the present invention, the side surface of the housing 20 is opened, and hence the ferrule 10 can be mounted to the housing 20 with one-touch operation. The optical connector can be preferably used on a place where the optical connector is rarely subjected to external impact (in an inside of a module box, for example). On such place, it is less necessary to protect the optical fiber with a resin jacket or the like, and the optical connector can be used in a state in which the optical fiber is exposed. As a matter of course, there may be used a so-called optical cable in which the optical fiber is protected with the resin jacket or the like and a reinforcing fiber is interposed between the resin jacket and the optical fiber.

The present invention is not limited to the above-mentioned embodiment. For example, in the above-mentioned embodiment, as illustrated in FIG. 4, though the gap is formed between the partially-tapered inner surface 32a of the holding hole 32 of the housing 20 and the tapered surface 12b2 of the ferrule 10, those surfaces may be brought into contact with each other (not shown). In this case, in a state in which the reference surfaces 32c are elastically deformed, the ferrule 10 is brought into contact with the housing 20 from the proximal end side of the flange portion 12b, and the flange portion 12b is sandwiched between the partially-tapered inner surface 32a and the reference surfaces 32c of the housing 20 from the both sides in the axial direction. As a result, the ferrule 10 can be reliably held by the housing 20.

### REFERENCE SIGNS LIST

1 optical connector
10 ferrule
11 capillary
12 capillary holding portion
12b flange portion
13 protective tube
20 housing
21 main body
21a protrusion
22 latch
22a locking surface
23 cover portion
30 through-hole
31 larger-diameter hole
32 holding hole
32a partially-tapered inner surface
32b partially-angled inner surface
32c reference surface
32d partially-rounded inner surface

1. An optical connector, comprising:
a ferrule comprising a flange portion; and
a housing comprising a through-hole formed to hold the ferrule therein,
wherein the through-hole is opened in a side surface of the housing, and the ferrule is allowed to be mounted to an inner periphery of the through-hole from an opening portion formed in the side surface.

2. An optical connector according to claim 1, further comprising a reference surface formed integrally with the housing, for regulating retreat of the ferrule by being brought into contact with the flange portion of the ferrule from a proximal end side thereof.

3. An optical connector according to claim 1, wherein the ferrule is detachably attached to the housing.

4. An optical connector according to claims 1, further comprising a cover portion which is formed integrally with the housing, covers an outer periphery of the ferrule projecting to the proximal end side thereof relative to the housing, and extends to the proximal end side relative to a proximal end of the ferrule.

5. An optical connector according to claim 1, wherein the ferrule is held in close contact with the housing on a cylindrical outer peripheral surface of the ferrule in a peripheral region extending over more than half of a circumference of the cylindrical outer peripheral surface.
